(19) United States
(12) Patent Application Publication
(10) Pub. No.: US 2005/0142503 A1
(43) Pub. Date: Jun. 30, 2005

(54) Concentrated azo dye solution, a staining kit comprising it, and a method for preparing a protein staining solution

(75) Inventor: Georges Nouadje, Evry (FR)

Correspondence Address: LERNER, DAVID, LITTENBERG,;KRUMHOLZ & MENTLIK, 600 SOUTH AVENUE WEST, WESTFIELD, NJ, 07090, US

(73) Assignee: SEBIA, Lisses (FR)

(21) Appl. No.: 10/996,510

(22) Filed: Nov. 24, 2004

(30) Foreign Application Priority Data
Nov. 26, 2003 (FR) 0313894

(51) Int. Cl. G03C 1/85

(52) U.S. Cl. 430/527

(57) ABSTRACT

The present invention concerns a presentation an azo dye for staining proteins to allow their analysis, in particular of the amido black type, which is a concentrate in a liquid medium, and to a method for preparing a protein staining solution. It also concerns staining kits comprising said concentrated stain solutions.

The present invention relates to a stable concentrated stain solution and to the use of said stable solution to stain proteins analyzed by electrophoresis, for example by gel electrophoresis.

Electrophoresis techniques, in particular gel electrophoresis, can be used to separate protein constituents of biological samples such as serum, blood, urine, cephalorachidian liquid, etc. The proteins, deposited on an electrophoretic support, for example a gel, migrate under the influence of an electric field. Since they migrate at different rates depending on their electric charge and/or their molecular weight, electrophoresis can separate the proteins. When migration is complete, the support, in this case a gel, is dried or undergoes a fixing step using a fixative. Alternatively, the proteins can be transferred onto a gel on another support, for example a membrane.

The support is then stained in a staining bath or with staining solution prepared for the purpose, to stain the proteins, allowing the protein fractions separated to be visualized with better contrast. As well as qualitative analysis, quantitative analysis of the protein fractions can be carried out by means of densitometric readings to obtain the percentage of each separated and stained protein fraction in the biological sample.

Usually, azo dyes are used, for example amido black, are used in acidic solution as the bath or staining solution. For regularity, accuracy and reproducibility of stained protein analyses, it is important for the staining solution used to be of consistent, comparable quality.

Usually, the stains used to carry out staining are available commercially in a concentrated form in a liquid medium, general in an aqueous acidic medium. Usually, a concentrated commercially available amido black stain in an acidic medium has a shelf life of about 2 or 3 years. This concentrated form is diluted to prepare the staining solution prior to use, as diluted ready-to-use staining solutions are not as stable, and it is advisable to use them within a month following their preparation.

It has now been established that, for the same sample, densitometry results, i.e. the percentages of each separated protein fraction which has been stained and detected, can vary as a function not only of the nature of the stain, of its composition, but also as a function of its concentration and in particular the age of the concentrated stain solution used to prepare the staining solution, i.e. its degree of degradation.

The analytical results obtained using a densitometer showed that the percentages of the fractions vary with the age of the concentrated stain. As an example, for the same human serum, the percentage of albumin can change from a value of 69%, determined with a diluted stain, i.e. a dilute staining solution diluted from fresh concentrated amido black, to a value of 63%, determined with a diluted staining solution obtained from a thirty month old amido black concentrate. A slight change in the colour of the stained gel has also been observed: diluted fresh concentrate induces a bright blue stain while diluted old concentrate induces a blue-black stain.

In order to make measurements of constant quality, and to avoid variations in the percentages of the fractions, one solution has been to use stains presented and stored in powder form. The powder is dissolved in an acid/water medium or acid/water/alcohol medium to prepare the stain at the point of use to stain the proteins. Again, it is advisable to use it within a month following preparation.

The powder form, however, suffers from the following disadvantages. During production, there are difficulties in distributing powder. Further, the disadvantages linked to this form of presentation (powder) are that it is difficult for a user to manipulate powders, which are generally very fine, which results in more uncertainty than in the liquid form, and also the dissolution time is fairly long.

Given the difficulties linked to powders, we sought to develop a presentation of a concentrated stain in liquid form which would permit fraction percentages which were independent of the age of the concentrated stain to be measured during a subsequent densitometric measuring step, for example.

There is thus a need to provide a presentation for an azo dye for staining proteins, in particular of the amido black stain type in a liquid concentrate, which can produce protein fraction measurements which do not vary with the age of the concentrated stain.

The present invention concerns a stain solution comprising an azo dye and a solvent for said dye, which solvent is non-acidic and miscible with water.

With the concentrated stain solutions of the invention, prolonged storage of the concentrate in the liquid form is possible without degradation of the staining power, i.e. the concentrated stain solutions are stable and can produce staining solutions of constant quality on demand, independently of the age of the stored concentrate when it is diluted to produce them.

Thus, the problem of stability of the concentrated solutions is overcome, as will be become apparent from the examples.

The present invention will be better understood from the following detailed description and accompanying drawings.

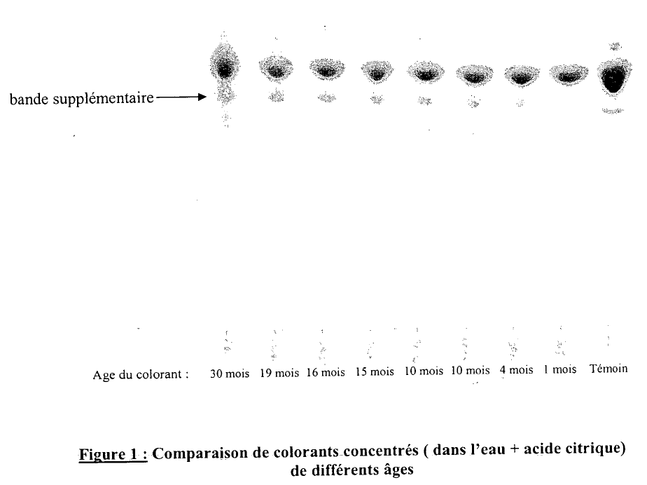

FIG. 1 shows the results of thin layer chromatography (TLC) of solutions of amido black stain in a prior art acidic medium with an age increasing from 1 to 30 months, from right to left, and with a control on the right.

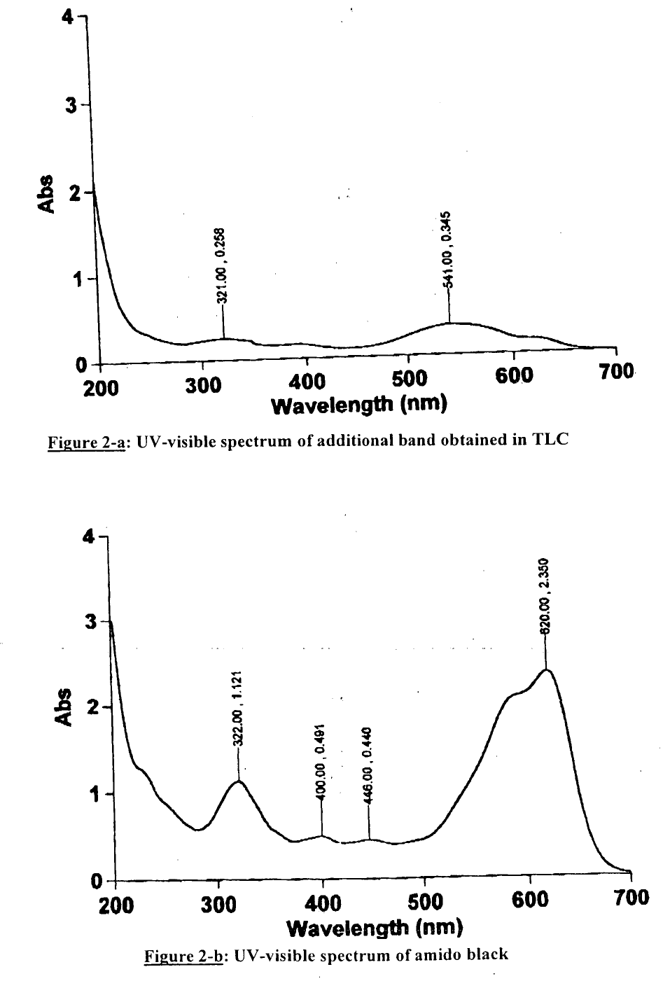

FIGS. 2A and 2B show the UV-visible spectrum corresponding to the additional band appearing in TLC for prior art staining solutions (2A) and the UV-visible spectrum of amido black (2B).

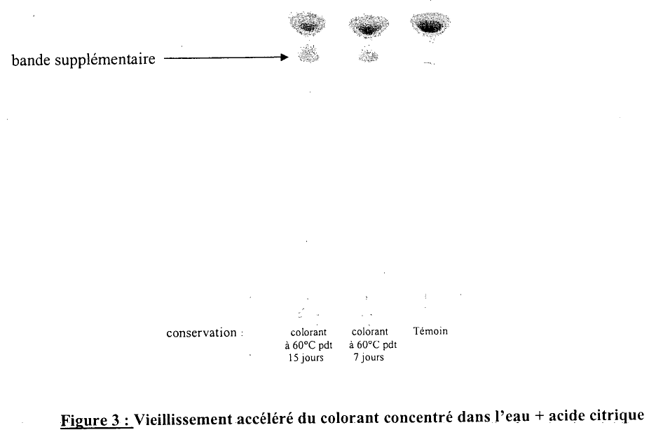

FIG. 3 shows the results of thin layer chromatography (TLC) of solutions of amido black stain in the acidic medium of the invention, after an accelerated ageing procedure of 7 and 15 days (from right to left, and with a control on the right).

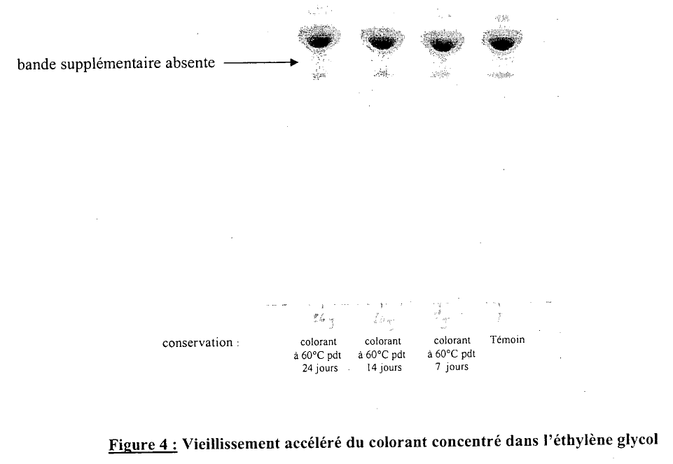

FIG. 4 shows the results of thin layer chromatography (TLC) of amido black stain solutions in an acidic medium of the invention, after an accelerated ageing procedure of 7, 14 and 24 days, from right to left, and with a control on the right.

The term “stain solution” is used here for concentrated solutions stored prior to dilution and use, and the term “staining solution” is used for the result of dilution, i.e. for ready-to-use solutions.

In accordance with the invention, the term “azo dye” is used to designate dyes from this chemical family, usually used to stain proteins, and more particularly those which can degrade in an acidic medium.

The stain of the invention is thus firstly the amido black stain, but the azo dye may also be selected from ponceau red, acid violet and Coomassie blue, for example.

The stain amido black is also known as naphthol blue black. Aqueous acetic acid/isopropanol solutions and powders are commercially available.

Thus, in one of its aspects, the invention allows the azo dye, in particular the amido black stain, to be stored in concentrated solution in a stable manner. This result is obtained by separating it during storage from the acidic medium in which it is normally prepared. The stain solutions of the invention are free of any constituents that can degrade the stain in solution under the influence of the acidity of this constituent.

In accordance with the invention, the solvents which can be used are non acidic solvents for the stain, i.e. those which can dissolve it, preserving it from degradation by an acid. Because of the subsequent use of the concentrated solutions, the solvents are selected from water-miscible solvents. Anhydrous solvents can be used.

The stain solutions are prepared by solubilizing the dye powder in the solvant in an usual manner.

Preferably, the solvents are selected from ethylene glycol, dimethylformamide, ethanol, methanol, dimethylsulphoxide, water, glycerol, benzyl alcohol and mixtures thereof, and in general any solvent for the stain which does not cause deterioration of the stain due to the acidity of the solvent.

Preferably, the solvent is selected from ethylene glycol, water and glycerol; more preferably, ethylene glycol is selected.

Regarding concentration, the stain solutions comprise about 4 grams of pure stain per 100 millilitres of solvent, up to the solubility limit of the stain in the selected solvent. For amido black namely, the stain solutions preferably comprise in the range 4 to 20 g of stain per 100 ml of solvent. These values, and those given in the examples, are given by way of illustration, as other dilutions are possible depending on the stain, the final aim being to obtain a staining solution comprising the usual concentration for its use, i.e. at least 1 gram per litre of staining solution. Stain solutions comprising 8 to 20 g of stain per 100 ml of solvent are also convenient.

The staining solutions are prepared extemporaneously at the point of use, and can be used in the months following their preparation.

They are prepared by diluting the concentrated solution with an acidic solution. At the point of use, the concentrated stain is taken up in an acid-and-water mixture to stain the proteins properly.

The acidic solutions are primarily aqueous or hydroalcoholic solutions of acids in routine use in staining solutions. Preferably, citric acid or acetic acid is used, but also fumaric acid, nitric acid, sulphosalicylic acid, phosphoric acid and trichloroacetic acid, for example, can be used, as well as mixtures thereof.

The alcohols which can be used in hydroalcoholic mixtures are the usual alcohols, for example selected from isopropanol, methanol and ethanol.

To obtain the staining solution, the stain solution can be diluted with or in a prepared acidic solution, or the stain solution can be mixed with water or another solvent mixture, for example a hydroalcoholic solution, which dilutes and introduces a solution of concentrated acid or pure acid. The dilution conditions are adjusted and the quantities of acid are adjusted to provide a pH of about 2 in the staining solution. the pH can optionally be adjusted at the point of use.

The invention also concerns the use of a concentrated solution as described above to prepare a protein staining solution. It can, for example, be prepared by dilution with an aqueous solution of dilute acid, or by mixing a suitable dose of concentrated acid with the staining solution and the diluent, for example water. The diluent is preferably water or any other mixture of diluent, solvent mixture, for example hydroalcoholic, which is compatible with the stain, water and acid, can also be used.

The invention also concerns its use for staining proteins after electrophoresis, in particular gel electrophoresis.

The invention also concerns staining kits comprising at least one stain solution, a dose of acid diluent or a dose of concentrated acid, and an optional diluent.

The following examples illustrate the invention without limiting it to the implementations described below.

Method for Evaluating the Stability of Concentrated Amido Black Solutions

The amido black stain for electrophoresis was in the concentrated form in a citric acid/water medium (1.2 g of stain in 75 ml of a 10% w/v citric acid solution). This concentrated stain solution was then diluted in water at the point of use (75 ml of concentrate diluted with 225 ml of water).

a) Variations in the percentages of fractions and colour of the stain were noted as a function of its age for the same analyzed sample, as can be seen in Table I below and in FIG. 1. Two 10 month old batches were used for the test.

TABLE I

| Age of stain | Percentage of human | |
|---|---|---|
| (months) | albumin fraction (%) | Colour of stain |
| 30 | 63 | blue-black |
| 19 | 64.9 | blue-black |
| 16 | 66.3 | |
| 15 | 66.1 | |
| 10 | 64.6 | |
| 10 | 64.5 | |
| 4 | 67.2 | |
| 1 | 68.3 | bright blue |
| 0 | 69 | bright blue |

b) Stain concentrates in an acid medium (1.2 g in 75 ml of 10% w/v citric acid solution) classified as a function of their age were also tested by thin layer chromatography (TLC). For use, the concentrated stain solutions in acidic medium were diluted 4-fold by adding 3 volumes of water to 1 volume of concentrated solution to give staining solutions comparable to the staining solutions described in a).

The results obtained show a perfect correlation between the age of the stain and the appearance or increase in intensity of an additional band the UV-visible spectrum of which, obtained using a spectrophotometer, was characteristic and different from that of amido black. At the same time, a reduction in the intensity of the principal band of amido black was observed with the age of the stain.

These observations are summarized in Table II below and are shown in FIG. 1 (TLC) and in FIGS. 2A and 2B (UV-visible spectra)—the arrow in FIG. 1 points to the additional band

TABLE II

| | Percentage of | |
|---|---|---|
| Storage conditions for | human albumin | |
| concentrated stain | fraction (%) | Colour of stain |
| 15 days at 60° C. | 63.2 | blue-black |
| 7 days at 60° C. | 65.7 | |
| 0 days at 60° C. | 69 | blue-black |

c) Conclusion The concentrated amido black stain prepared in solution in an acid/water mixture as described above and stored at 60° C., b), showed signs of degradation which were identical to those for the same stain prepared in the same manner but stored at ambient temperature for 30 months, a). A modification in the percentage of protein fractions, a change in the colour of the stain, and also in TLC the appearance of an additional band were observed (see FIG. 3 and Table II compared with Table I).

The arrow in FIG. 3 points to the additional band.

It can be concluded that storing a stain at 60° C. for 14 days is equivalent to storing the same stain at ambient temperature for 30 months, and that this accelerated ageing protocol can validly be used to illustrate natural ageing at ambient temperature.

### EXAMPLE 1

16 g of powdered amido black sold by Merck was added to 100 ml of ethylene glycol and stirring was carried out until it had completely dissolved. The stain solution was obtained.

8 ml of this stain solution was removed and diluted in 292 ml of a 10% (w/v) citric acid solution. The ready-to-use staining solution was thus obtained; its pH was about 2.

### EXAMPLES 2 AND 3

The procedure of Example 1 was repeated, replacing the ethylene glycol with glycerol and water in the same proportions to obtain stain solutions.

Staining solutions with a pH of about 2 were obtained under the same dilution conditions.

### EXAMPLE 4

### Evaluation of the Stability of the Concentrated Stain of the Invention

The results of Table III for the concentrated stain solution of Example 1 were obtained under the conditions of the method described above.

TABLE III
Variation in the percentage of albumin in human serum as a function
of the storage conditions of the concentrated stain in an ethylene glycol
medium, as shown in FIG. 4.

| | Percentage of | |
|---|---|---|
| Storage conditions for | human albumin | |
| concentrated stain | fraction (%) | Colour of stain |
| 24 days at 60° C. | 69.2 | bright blue |
| 14 days at 60° C. | 69.1 | bright blue |
| 7 days at 60° C. | 69.5 | bright blue |
| 0 days at 60° C. | 69.1 | bright blue |

The arrow emphasizes the absence of an additional band.

It can be seen that the concentrated stain solution of Example 1 is stable compared with the conventional acidic concentrated solution.

### EXAMPLE 5

A kit comprised 8 ml of the stain solution of Example 1 and a flask containing 60 ml of concentrated citric acid (50% w/v). By mixing these 8 ml with the content of the flask and adding water up to 300 ml, a staining solution with a pH of about 2 was obtained.

1. A stain solution comprising an azo dye and a solvent for said dye, which solvent is non acidic and miscible with water, the stain solution comprising about 4 g of dye per 100 milliliters of solvent, up to the solubility limit of said dye in said solvent.

2. The stain solution according to claim 1, wherein the azo dye is capable of degrading in an acidic medium.

3. The solution according to claim 1 or claim 2, wherein the azo dye is selected from ponceau red, acid violet, Coomassie blue and amido black stain.

4. The solution according of claim 3, wherein the stain is amido black stain.

5. The solution according claim 1 wherein the solvent is selected from ethylene glycol, dimethylformamide, ethanol, methanol, dimethylsulphoxide, water, glycerol, benzyl alcohol and mixtures thereof.

6. The solution according to claim 1, wherein the solvent is selected from ethylene glycol, water and glycerol and mixtures thereof.

7. The solution according claim 6, wherein the solvent is ethylene glycol.

8. A method for preparing a staining solution, comprising adding extemporaneously to a stain solution comprising an azo dye and a solvent for said dye, which solvent is non acidic and miscible with water,
(1) an acidic aqueous solution or an hydroalcoholic solution; or
(2) an aqueous solution or hydroalcoholic solution, the staining solution being extemporaneously added with acid.

9. The method according to claim 8, further comprising adjusting pH of the staining solution to a value of about 2.

10. The method according to claim 8, wherein the acidic aqueous acids are selected from citric, acetic, fumaric, nitric, trichloroacetic, sulphosalicylic and phosphoric acids and mixtures thereof.

11. The method according to claim 10, wherein the acid is citric acid or acetic acid.

12. Use of a solution according to one of claims 1 to 7, for the preparation of a protein staining solution.

13. Use according to claim 12, characterized in that the proteins are stained following gel electrophoresis.

14. A staining kit comprising at least one stain solution according to claim 1 a dose of acid diluent or a dose of concentrated acid, and a diluent.

15. Stain solution consisting essentially of an azo dye selected from ponceau red, acid violet, Coomassie blue and amido black stain and at least one non acidic solvent thereof miscible with water, the stain solution comprising about 4 g of dye per 100 milliliters of solvent, up to the solubility limit of said dye in said solvent.

16. Method of stabilizing a stain solution of an azo dye for storing purposes comprising diluting said dye with a non acidic, water-miscible solvent of said dye.
